(19) United States
(12) Patent Application Publication
(10) Pub. No.: US 2010/0320180 A1
(43) Pub. Date: Dec. 23, 2010

(54) TEXTURED IMPRESSIONS FOR MAKING JEWELRY COMPONENTS

(76) Inventor: Candace A. Anne Gates, San Juan Capistrano, CA (US)

Correspondence Address: Candace A. Gates, Suite 201, 27134B Paseo Espada, San Juan Capistrano, CA, 92675, US

(21) Appl. No.: 12/820,729

(22) Filed: Jun. 22, 2010

Related U.S. Application Data
(60) Provisional application No. 61/219,445, filed on Jun. 23, 2009.

(51) Int. Cl. B23K 26/36; A44C 27/00; B29C 59/00; B29C 59/02

(52) U.S. Cl. 219/121.69; 29/896.41; 425/385; 264/224

(57) ABSTRACT

A purpose-designed textured impression is described for producing components used in jewelry making. The purpose-designed texture impression comprises a geometric shape for a specific component of an end-item jewelry piece, a texture or design that specifically follows the geometric shape, and a means for applying the impression of specific shape and integral texture into a desired medium.

The application claims the benefit of U.S. Provisional Patent Application No. 61/219,445, filed Jun. 23, 2009, which is entirely incorporated herein by reference.

### FIELD OF THE INVENTION

The present invention generally relates to textured impressions for jewelry components; more particularly, the present invention relates to purpose-designed, pre-formed and shape-specific textured impressions for making jewelry components.

### BACKGROUND OF THE INVENTION

In recent years, both hobbyist and professional jewelry makers have utilized a variety of products, including polymer and metal clays, as a medium for jewelry designs that are readily available and require much less training and investment than conventional bench jewelry making. These materials are relatively soft and malleable; may be easily shaped into a desired form; and may be imparted with a unique and custom appearance by pressing any object (e.g., cookie cutters, coins, stencils, buttons, etc.) with a desired surface texture (e.g., a leaf, rock, wood, burlap clothe, pasta) into the material.

Various textures have become available that offer unique appearance as well as consistency and the ability to be used more than once. These textures may be made in a rubber stamp, metal plate or mold to impart the appearance to the clay. Current textures are typically oversized in a square or rectangular sheet with a repeating pattern.

A limitation of the use of current textures is that patterns, textures and designs imparted a the raw-shaped piece are not shape-specific and, therefore, do not follow or conform to the geometry of the final jewelry piece, resulting in an abstract look as opposed to an integral and professional look. For example, with reference to FIG. 1, a resulting jewelry piece having a non-shape specific texture (or pattern) is formed from a non-shape specific commercial texture. The resulting jewelry piece can be cut from the larger commercial texture.

Because of the non-shape specific nature of current textures, use of textures makes it difficult to achieve a consistent design throughout all of the components of the final jewelry piece. Additionally, with current textures, edges are not predefined, and final jewelry pieces might not have a professional, jewelry-quality appearance. Further, in cases where consistency in shape and design from one jewelry piece to another is important, given that various portions of the final jewelry piece are made using different textures, formation of the final jewelry piece might require assembly of the individual portions, which might lead to one final jewelry piece being significantly different from another.

Accordingly, there is a need in the art for methods and impressions that are capable of creating jewelry pieces in fewer processing steps than current methods.

### SUMMARY OF THE INVENTION

The present invention can be used to impart a purpose-designed, specific shape and integral design to any soft and malleable substrate that must resultingly be fired or cured to proper hardness and final form, including precious metal clay, art clay, polymer clay, organic materials, plastics, glass clay, polymer clay, resin, powdered metal or glass, or other clay or malleable materials.

The artist can design jewelry article using manual or computer means. The design will include all of the purpose-designed shapes, integral design textures and borders necessary to convey the desired them and vision. The artists desired negative images are then reproduced on a medium that is selectively etched to form a positive image suitable for the transfer to the various mediums selected by jewelry artists.

In an aspect of the invention, a textured impression for producing components used in jewelry making is provided, comprising a geometric shape for a specific component of an end-item jewelry piece; a texture or design that specifically follows the geometric shape; and a means for applying the impression of specific shape and integral texture into a desired medium.

In another aspect of the invention, a purpose-designed template for forming a jewelry piece is provided, the purpose-designed template comprising a first design that is an inverse image of a second design substantially defining the jewelry piece, the purpose-designed template configured to form the second design in a clay material.

In yet another aspect of the invention, a method for forming a jewelry piece is provided, comprising pressing a clay material having one or more metals onto a template, the template having a first design, wherein pressing the clay material onto the template forms a second design in the clay material, the second design being a negative image of the first design; removing the clay material from the template; and annealing the clay material.

In still another aspect of the invention, a method for forming a template for use in producing a jewelry piece is provided, comprising forming a master template, the master template formed from a metallic material, the master template having a design that is an inverse of or that substantially matches a design of the jewelry piece; and forming a matrix template from the master template, the matrix template formed from a polymeric material, the matrix template having a design that is an inverse of the design of master template.

### INCORPORATION BY REFERENCE

All publications, patents, and patent applications mentioned in this specification are herein incorporated by reference to the same extent as if each individual publication, patent, or patent reference was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts a prior art process and resulting jewelry pieces imparted with a non-shape specific texture (or design);

FIG. 2 depicts the invention and resulting jewelry pieces imparted with a distinctive and shape specific design, in accordance with an embodiment of the invention;

FIG. 3 depicts a simplified purposed-designed, shaped, textured impression illustrating the geometric shape for a specific component of a end-item jewelry piece; the texture that specifically follows the geometric shape; and the means to apply the impression of specific shape and integral texture into the artist's preferred medium, in accordance with an embodiment of the invention;

FIG. 4 depicts a purposed-designed, shaped, textured impression design to produce for example a pendant piece, illustrating the specific shape and design conformity, in accordance with an embodiment of the invention;

FIG. 5 depicts a purposed-designed, shaped, textured impression design to produce for example a bracelet charms, illustrating the specific shape and design conformity, in accordance with an embodiment of the invention, in accordance with an embodiment of the invention;

FIG. 6 depicts a purposed-designed, shaped, textured impression design to produce for example bail strips, illustrating the specific shape and design conformity, in accordance with an embodiment of the invention;

FIG. 7 depicts a purposed-designed, shaped, textured impression design to produce for example a traditional bail, illustrating the specific shape and design conformity, in accordance with an embodiment of the invention; and

FIG. 8 depicts a purposed-designed, shaped, textured impression design to produce for example a clasp, illustrating the specific shape and design conformity, in accordance with an embodiment of the invention.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein can be employed in practicing the invention

Currently, jewelry artists are limited to the use of commercially available shapes and textures that are typically generic, repeating patterns that might not be suitable to the artist's theme. According to current methods, the finished jewelry product might be a collage of shapes and textures formed using various components that might be formed at different times or using different textures.

In embodiments of the present invention, methods and apparatuses are provided for eliminating the limitations of prior art methods. Methods of preferable embodiments provide a jewelry artist (also “artist” herein) the capability of producing jewelry articles that convey the artist's theme and vision with a professional, cohesive and uniform look and finish.

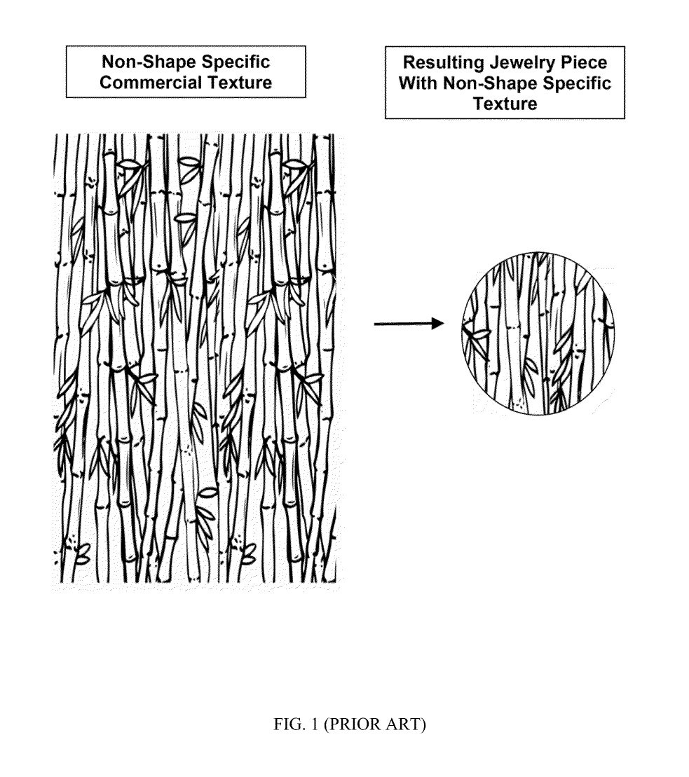

The term “purpose-designed” template, as used herein, can refer to a template having a design (including geometric shapes and textures) that substantially defines the design of a jewelry product. In this respect, the design of the template substantially defines the entirety of the jewelry product. Conversely, the commercial texture of FIG. 1 is not purpose-designed because the design of the final jewelry product is a portion of the design of the commercial texture.

In embodiments, purpose-designed templates (also “textured impressions” herein) are provided for forming jewelry items. Textured impressions of embodiments comprise one or more geometric shapes that substantially define the shape and/or design of a final piece of jewelry (also “jewelry item” herein). In this respect, use of textured impressions of embodiments of the invention to make jewelry items requires fewer processing steps, such as, e.g., cutting and combining pieces to form a finished product. In various embodiments, a textured impression entirely defines a jewelry item for use by a user.

### Textured Impressions

In an aspect of the invention, a textured impression for producing components used in jewelry making is provided. The textured impression comprises a geometric shape for a specific component of an end-item jewelry piece; a texture or design that specifically follows the geometric shape; and a means for applying an impression of specific shape and integral texture into a desired medium. In an embodiment, the desired medium is a clay material comprising one or more metals for forming the specific component of the end-item jewelry piece. In an embodiment, the specific component of the end-item jewelry piece is the entirety of the end-item jewelry piece.

In embodiments, the geometric shape can include one or more patterns or designs that substantially define an end piece jewelry item. In an embodiment, the geometric shape defines the entirety of the end piece jewelry item.

In an embodiment, the geometric shape can be specifically for a pendant, bail or bezel. In another embodiment, the geometric shape is long and rectangular and is specifically for a bail strip. In yet another embodiment, the geometric shape is specifically for a charm. The geometric can define the entirety of the charm. In still another embodiment, the geometric shape is specifically for a ring. The geometric shape can define the entirety of the ring. In an embodiment, the geometric shape is specifically for a bangle, bracelet or bracelet component. The geometric shape can define the entirety of the bangle, bracelet or bracelet component. In still another embodiment, the geometric shape is specifically for an earring or earring component. The geometric shape can define the entirety of the earring or earring component. In still another embodiment, the geometric shape is specifically for a chain component. The geometric shape can define the entirety of the chain component. In still another embodiment, the geometric shape is specifically for a clasp, interconnecting ring or finding. The geometric shape can define the entirety of the clasp, interconnecting ring or finding.

In an embodiment, a die custom to the outside shape of the impression is affixed to allow the user to simultaneously impart the impression and trim excess material from the component (e.g., jewelry item) being fabricated.

In an embodiment, the impression can be applied with the aid of a rubber sheet, block or stamp. In another embodiment, the impression can be applied with the aid of a wood sheet or block. In still another embodiment, the impression can be applied with the aid of a metal sheet or block. In still another embodiment, the impression can be applied with the aid of an organic or resin-based impression sheet or block.

In another aspect of the invention, a purpose-designed template for forming a jewelry piece is provided, the purpose-designed template comprising a first design that is an inverse image of a second design substantially defining the jewelry piece. In an embodiment, the purpose-designed template is configured to form the second design in a clay material.

In embodiments, the purpose-designed template is formed of a polymeric material. In an embodiment, the purpose-designed template is formed of rubber.

Reference will now be made to the figures. It will be appreciated that the figures are not drawn to scale.

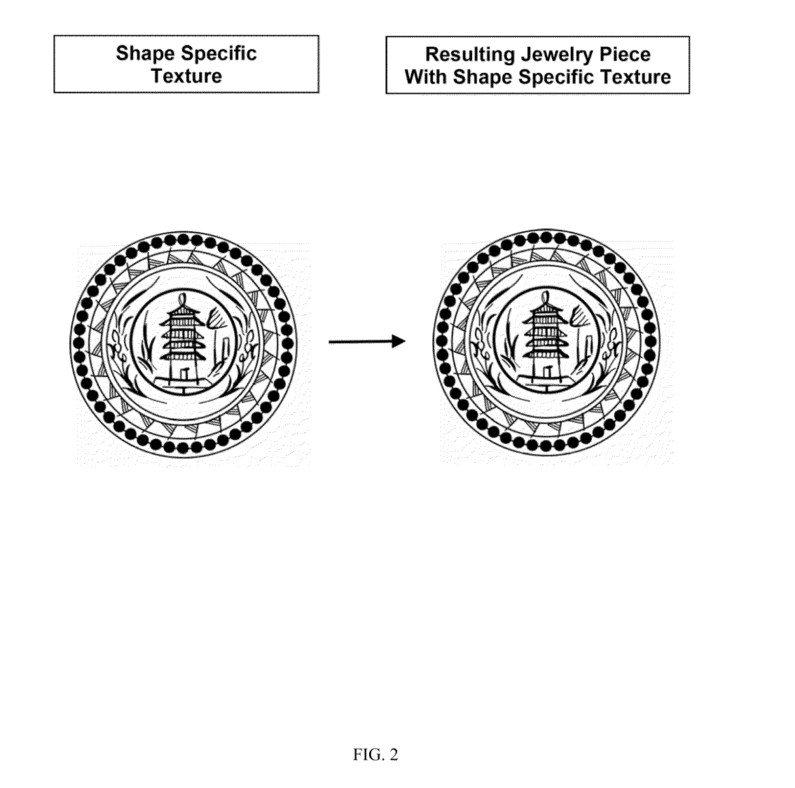

With reference to FIG. 2, in an embodiment, a shape specific texture (also “template” herein) is shown (left) that can be used to form a jewelry piece (right) having a shape and design that substantially matches (or conforms to) the shape and design of the texture.

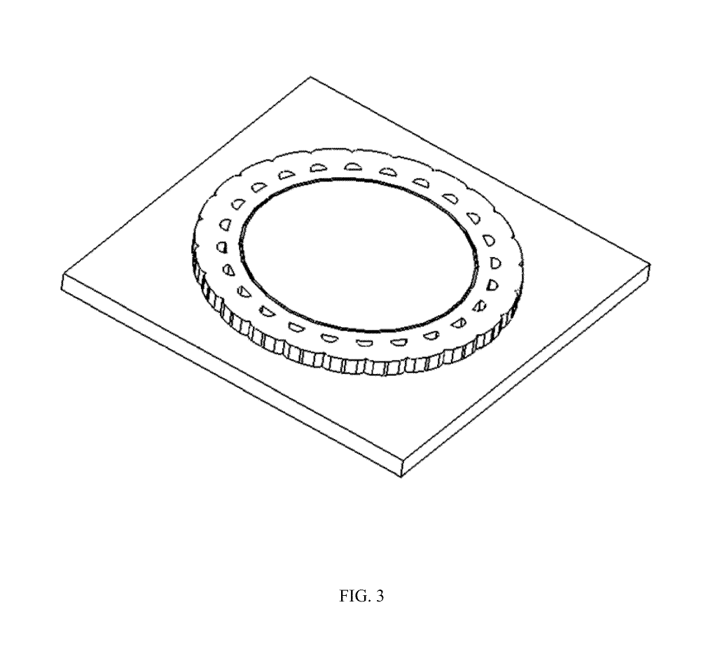

With reference to FIG. 3, in an embodiment, a simplified purposed-designed, shaped, textured impression (template) is shown, the template having a design that comprises a geometric shape and texture. The design, including the geometric shape, is for a specific component of an end-item jewelry piece. The texture specifically and substantially follows the geometric shape. The template comprises a means for applying the design (or impression) of specific shape and integral texture into an artist's preferred medium (e.g., clay).

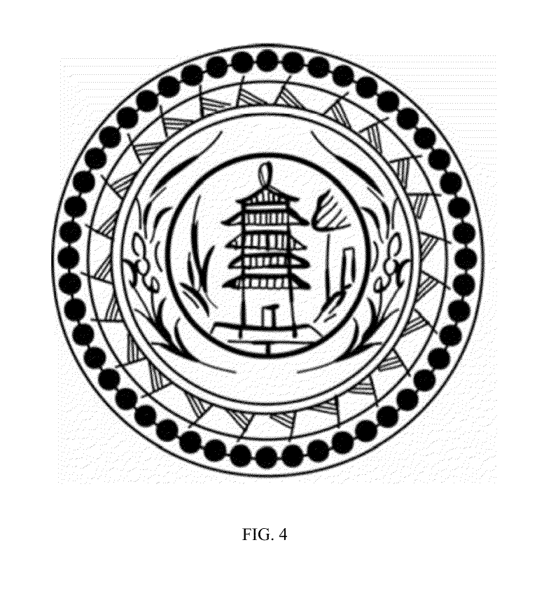

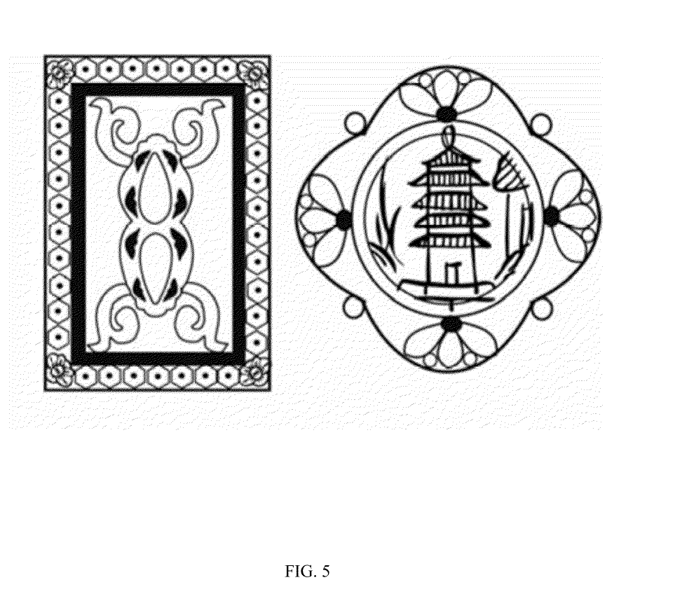

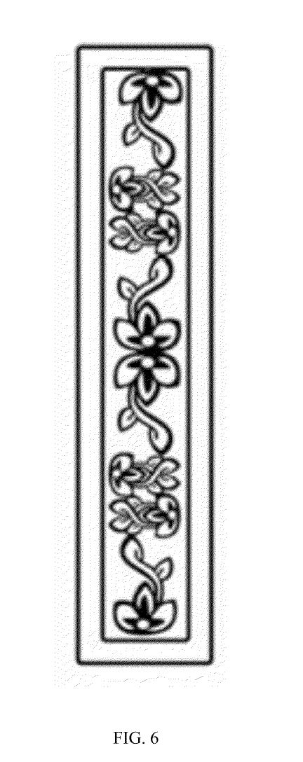

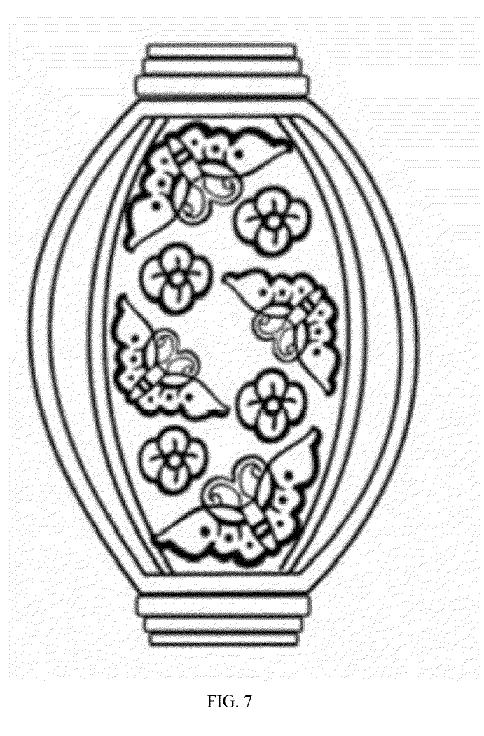

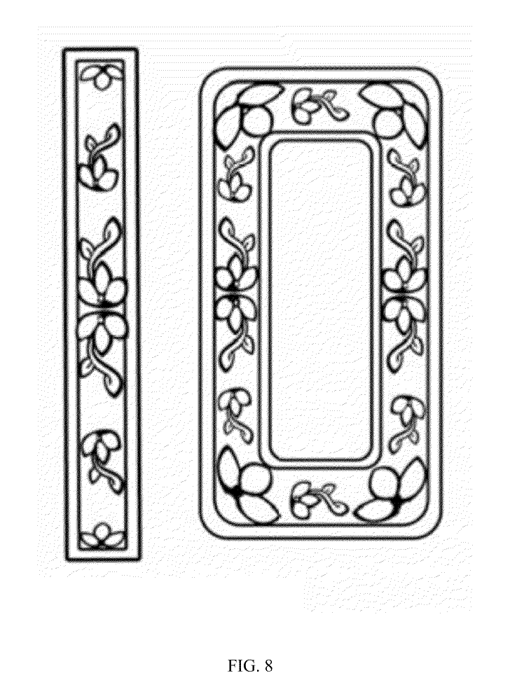

Templates of embodiments of the invention can have various shapes and designs (including geometric shapes and textures). FIG. 4 shows a purposed-designed template for forming pendant piece, in accordance with an embodiment of the invention. FIG. 5 shows a purposed-designed template for forming bracelet charms, in accordance with an embodiment of the invention. FIG. 6 shows a purposed-designed for forming bail strips, in accordance with an embodiment of the invention. FIG. 7 shows a purposed-designed for forming traditional bails, in accordance with an embodiment of the invention. FIG. 8 shows a purposed-designed template for forming clasps, in accordance with an embodiment of the invention.

### Methods for Forming Jewelry Items Using Purpose-Designed Templates

In yet another aspect of the invention, purpose-designed templates, such as the template of FIG. 3, can be used to form metallic and non-metallic jewelry items.

In an embodiment, a method for forming a metallic jewelry piece is provided. The method comprises pressing a clay material having one or more metals onto a template (or master template), the template having a first design, wherein pressing the clay material onto the template forms a second design in the clay material, the second design being a negative image of the first design. In an embodiment, the clay material is pressed onto the template with the aid of a user's hand pressure. In another embodiment, the clay material is pressed onto the template with the aid of a mechanical device, such as a roller or a press. Next, the clay material is removed from the template. The clay material is then dried and annealed. In an embodiment, the clay material is dried at room temperature before annealing. In an embodiment, the clay material is annealed at a temperature sufficient to remove any solvent (and other non-metallic substances) from the clay material. In an embodiment, the annealing temperature is selected based on the clay material used to form the jewelry piece. In embodiments, the annealing temperature is between about 225° C. and 2800° C. For polymer clays, the annealing temperature can be between about 225° C. and 350° C., and the annealing time can be between about 30 minutes and 2 hours. For metal or ceramic clays (i.e., clay materials comprising metal or ceramic components), the annealing temperature can be between about 700° C. and 2800° C., and the annealing time can be between about 30 minutes and 22 hours. In some embodiments, the clay material can be air dried at room temperature.

In an alternative embodiment, the method described above can be used to form a non-metallic jewelry item, such as a glass jewelry item. The clay material having the second design is annealed to form a second template having one or more metals (e.g., Ag). While the metallic piece can serve as the jewelry item in certain embodiments, in this alternative embodiment the metallic piece will serve as another (second) template. The second template comprises the second design that is an inverse image of the first design. The second template can then be used to imprint the second design in molten glass, the molten glass comprising SiOₓ, wherein ‘x’ is a number greater than or equal to 1. This forms an inverse image of the second design in the molten glass. In an embodiment, the second template is brought in contact with molten glass to form a third design in the molten glass, the third design being an inverse image of the second design. The third design is substantially similar to the first design of the template. Next, the molten glass is cooled to form the jewelry piece.

In embodiments, the clay material comprises one or more metals selected from the group consisting of silver, platinum, gold, copper, titanium, bronze, magnesium and titanium. In an embodiment, the clay material comprises silver.

As yet another alternative, the template having the first design can be brought in contact with molten glass to form a fourth design in the molten glass, the fourth design being an inverse image of the first design. The molten glass can then be cooled to form a jewelry piece having the fourth design.

### Master Templates

In another aspect of the invention, a method for forming a template for use in producing a jewelry piece is provided. The method comprises forming a master template, the master template formed from a metallic material. In an embodiment, the master template has a design that is an inverse (or negative image) of the jewelry piece. In another embodiment, the master template has a design that substantially matches a design of the jewelry piece. Next, a matrix template is formed from the master template. In an embodiment, the matrix template is formed from a polymeric material. The matrix template includes a design that is an inverse (or negative image) of the design of master template. In an embodiment, the matrix template defines the template for use in producing the jewelry piece.

In an embodiment, laser etching is used to form the design of the master template. In another embodiment, the master template is formed by photolithography.

In an embodiment, the metallic material of the master template comprises one or more metals selected from the group consisting of aluminum, nickel, copper, ruthenium, iron, manganese, molybdenum and magnesium. In an embodiment, the metallic material of the master template is formed of stainless steel.

In an embodiment, the polymeric material is formed of rubber. In embodiments, the polymeric material is selected so as to be stable at elevated temperatures. In an embodiment, the polymeric material is stable at a temperature greater than or equal to about 100° C., or greater than or equal to about 200° C., or greater than or equal to about 300° C., or greater than or equal to about 400° C., or greater than or equal to about 500° C., or greater than or equal to about 600° C., or greater than or equal to about 700° C., or greater than or equal to about 800° C., or greater than or equal to about 900° C., or greater than or equal to about 1000° C.

In an embodiment, the design of the master template is an inverse of the design of the jewelry piece.

In an alternative embodiment, a die template is formed from the matrix template. The die template can be formed of a polymeric material. In an embodiment, the die template has a design that is an inverse of the design of the matrix template.

### Example

Approximately 18 g of a PMC+ clay (Mitsubishi Materials, 99.9% Ag) was used to form a jewelry item. The clay was initially kneaded. The clay was then shaped in a rough rectangular shape before rolling out. Rolling guides were used to roll the clay to cover a portion of a metallic stamp (template) having a texture defining a design. The rolling guides were approximately 2 millimeters thick. With the clay rolled out, the clay was placed over the lower left hand portion of the stamp. A Teflon sheet was placed over the clay and rolled up and down lengthwise, applying even pressure with each pass. The texture sheet was then rotated about 90 degrees and rolled from side to side, applying even pressure with each pass. After rolling the clay over the stamp, the Teflon and stamp were flipped over. The texture stamp was then peeled off the clay. Excess clay was then removed by cutting around the negative impression of the design in the clay. The clay was then allowed to dry. The dried clay defined a pendant. Next, all sides of the dry pendant were filed (with the aid of sandpaper) to provide smooth edges. A hole was drilled in a top portion of the pendant for hanging the pendant. Next, with the pendant dried completely, the pendant was inspected for cracks. Any cracks were repaired and dried. Next, the pendant was annealed (or fired) in a firing oven at the appropriate temperature and time for the clay product. For PMC+, the pendant was annealed at about 1650° C. for about 2 hours. The fired pendant was then removed from the firing oven and allowed to cool. A brass brush was used to clean away the clay dust from the fired pendant. The fired and cooled pendant was then processed per a desired finishing procedure (e.g., paint finish), dried and polished.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

I claim:

1. A textured impression for producing components used in jewelry making, comprising:
a geometric shape for a specific component of an end-item jewelry piece;
a texture or design that specifically follows the geometric shape; and
a means for applying the impression of specific shape and integral texture into a desired medium.

2. The textured impression of claim 1, wherein the geometric shape is specifically for a pendant.

3. The textured impression of claim 1, wherein the geometric shape is specifically for a bail.

4. The textured impression of claim 1, wherein the geometric shape is specifically for a bezel.

5. The textured impression of claim 1, wherein the geometric shape is long and rectangular and is specifically for a bail strip.

6. The textured impression of claim 1, wherein the geometric shape is specifically for a charm.

7. The textured impression of claim 1, wherein the geometric shape is specifically for a ring.

8. The textured impression of claim 1, wherein the geometric shape is specifically for a bangle, bracelet or bracelet component.

9. The textured impression of claim 1, wherein the geometric shape is specifically for an earring or earring component.

10. The textured impression of claim 1, wherein the geometric shape is specifically for a chain component.

11. The textured impression of claim 1, wherein the geometric shape is specifically for a clasp.

12. The textured impression of claim 1, wherein the geometric shape is specifically for a interconnecting ring or finding.

13. The textured impression of claim 1, wherein a die custom to the outside shape of the impression is affixed to allow the artisan to simultaneously impart the impression and trim excess material from the component being fabricated.

14. The textured impression of claim 1, wherein the means to apply the impression is a rubber sheet, block or stamp.

15. The textured impression of claim 1, wherein the means to apply the impression is a wood sheet or block.

16. The textured impression of claim 1, wherein the means to apply the impression is a metal sheet or block.

17. The textured impression of claim 1, wherein the means to apply the impression is an organic or resin based impression sheet or block.

18. A purpose-designed template for forming a jewelry piece, the purpose-designed template comprising a first design that is an inverse image of a second design substantially defining the jewelry piece, the purpose-designed template configured to form the second design in a clay material.

19. The purpose-designed template of claim 18, wherein the purpose-designed template is formed of a polymeric material.

20. A method for forming a jewelry piece, comprising:
pressing a clay material having one or more metals onto a template, the template having a first design, wherein pressing the clay material onto the template forms a second design in the clay material, the second design being a negative image of the first design;
removing the clay material from the template; and
annealing the clay material.

21. The method of claim 20, wherein pressing the clay material comprises bringing the clay material in contact with a portion of the template.

22. The method of claim 21, further comprising rolling the clay to cover a portion of the template.

23. The method of claim 22, further comprising rotating the template by about 90° and rolling the clay to cover a remainder of the template.

24. The method of claim 22, further comprising providing a Teflon sheet over the clay and template prior to rolling the clay.

25. The method of claim 22, wherein rolling the clay comprises using rolling guides having a thickness of about 2 millimeters.

26. The method of claim 22, wherein removing the clay material from the template comprises flipping the template over and peeling the template off of the clay material.

27. The method of claim 20, wherein the clay material is annealed at a temperature between about 700° C. and 2800° C.

28. The method of claim 27, wherein the clay material is first dried at room temperature prior to annealing.

29. The method of claim 20, wherein the clay material is annealed for a time period between about 30 minutes and 4 hours.

30. The method of claim 20, wherein annealing the clay material forms a second template having one or more metals, the second template having the second design.

31. The method of claim 30, further comprising bringing the second template in contact with molten glass to form a third design in the molten glass, the third design being an inverse image of the second design.

32. The method of claim 31, further comprising cooling the molten glass to form the jewelry piece.

33. The method of claim 20, wherein the one or more metals are selected from the group consisting of silver, platinum, gold, copper, titanium, bronze, magnesium and titanium.

34. The method of claim 20, wherein pressing comprises using hand pressure.

35. A method for forming a template for use in producing a jewelry piece, comprising:
forming a master template, the master template formed from a metallic material, the master template having a design that is an inverse of or that substantially matches a design of the jewelry piece; and
forming a matrix template from the master template, the matrix template formed from a polymeric material, the matrix template having a design that is an inverse of the design of master template.

36. The method of claim 35, wherein the design of the master template is formed by laser etching.

37. The method of claim 35, wherein the master template is formed by photolithography.

38. The method of claim 35, wherein the metallic material comprises one or more metals selected from the group consisting of aluminum, nickel, copper, ruthenium, iron, manganese, molybdenum and magnesium.

39. The method of claim 35, wherein the polymeric material is rubber.

40. The method of claim 35, wherein the design of the master template is an inverse of the design of the jewelry piece.

41. The method of claim 40, further comprising forming a die template from the matrix template, the die template formed of a polymeric material, the die template having a design that is an inverse of the design of the matrix template.
